(19) United States
(12) Patent Application Publication
(10) Pub. No.: US 2016/0224258 A1
(43) Pub. Date: Aug. 4, 2016

(54) GENERATING COMPUTER PROGRAMS FOR USE WITH COMPUTERS HAVING PROCESSORS WITH DEDICATED MEMORY

(71) Applicant: Microsoft Technology Licensing, LLC, Redmond, WA (US)

(72) Inventors: Ivan Nevraev, Redmond, WA (US); Cole Brooking, Woodinville, WA (US); J. Andrew Goossen, Issaquah, WA (US); Jason Strayer, Seattle, WA (US)

(21) Appl. No.: 14/612,230

(22) Filed: Feb. 2, 2015

(51) Int. Cl. G06F 3/06

(52) U.S. Cl. CPC G06F 3/0619; G06F 3/065; G06F 3/067; G06F 3/0631

(57) ABSTRACT

To optimize utilization of such dedicated memory by a particular application, the application is executed with multiple permutations of placement of data in the dedicated memory. That application is executed on a target platform, and snapshots of the application during execution are captured on the target platform. A snapshot is a log that includes data and commands passed between the central processing unit and the graphics processing unit of the target platform to generate a single frame of graphics data. Given a snapshot, multiple permutations of resource placement are generated and tested by re-executing the snapshot on the target platform. For multiple snapshots and multiple permutations for each snapshot, the computer system accesses or computes performance statistics. Based on the performance statistics, the computer system determines a layout of data for using the dedicated memory.

### BACKGROUND

In some computer systems, a processor can have a dedicated memory, such as an embedded static random access memory (ESRAM) or other dedicated, high-bandwidth memory. Such a memory generally provides fast processing with low latency, compared to other memory, but is limited in size. For example, a computer system with a graphics processing unit (GPU) as a coprocessor can have a fixed amount of dedicated memory with high bandwidth access for the GPU. Such a dedicated memory is specially designed to handle certain kinds of operations efficiently, particularly for use as a render target during image processing.

Computer programs running on such computer systems are written to take advantage of the dedicated memory by specifying which data should be maintained in the dedicated memory. As a particular example, the computer program is written to specify that certain portions of the dedicated memory are to be used as the render target for a particular image processing operation. It can be difficult for developers to determine how to efficiently use this dedicate memory.

### SUMMARY

This Summary is provided to introduce a selection of concepts in a simplified form that are further described below in the Detailed Description. This Summary is intended neither to identify key or essential features, nor to limit the scope, of the claimed subject matter.

To optimize utilization of such dedicated memory by a particular application, the application is executed with multiple permutations of placement of data in the dedicated memory. That application is executed on a target platform, and snapshots of the application during execution are captured on the target platform. A snapshot is a log that includes data and commands passed between the central processing unit and the graphics processing unit of the target platform to generate a single frame of graphics data.

Given a snapshot, multiple permutations of resource placement are generated and tested by re-executing the snapshot, with these different resource placements, on the target platform. For multiple snapshots and multiple permutations for each snapshot, the computer system accesses or computes performance statistics. Based on the performance statistics, the computer system determines a layout of data for using the dedicated memory.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a block diagram of an example computer system for a development environment.

FIG. 2 a flow chart describing operation of an example implementation of such a computer system.

FIG. 3 is a data flow diagram of an example implementation of the development environment.

FIG. 4 is a flow chart describing an example implementation of generating resource allocations.

FIG. 5 is a block diagram of an example computer in which components of such a system can be implemented.

### DETAILED DESCRIPTION

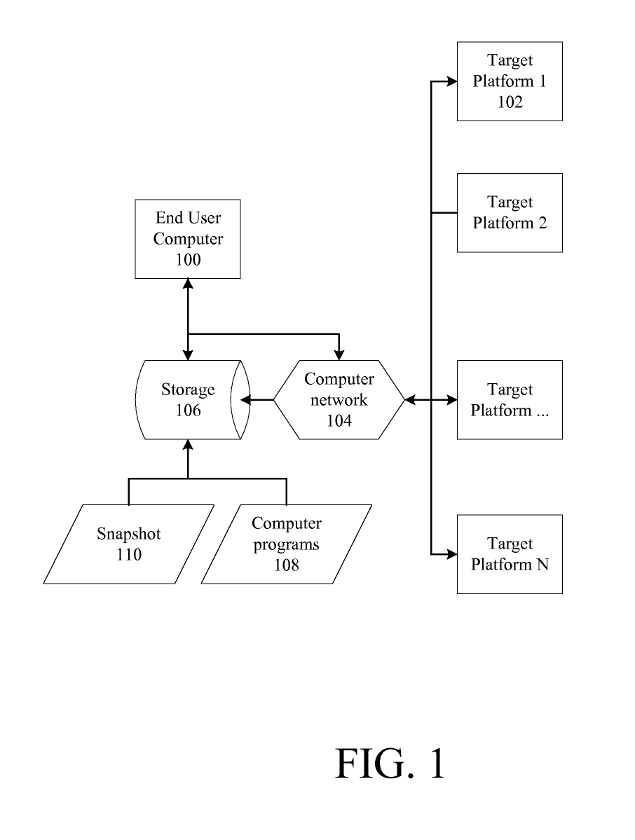

FIG. 1 is a block diagram of an example computer system for a development environment for developing applications that take advantage of a dedicated memory for a processor.

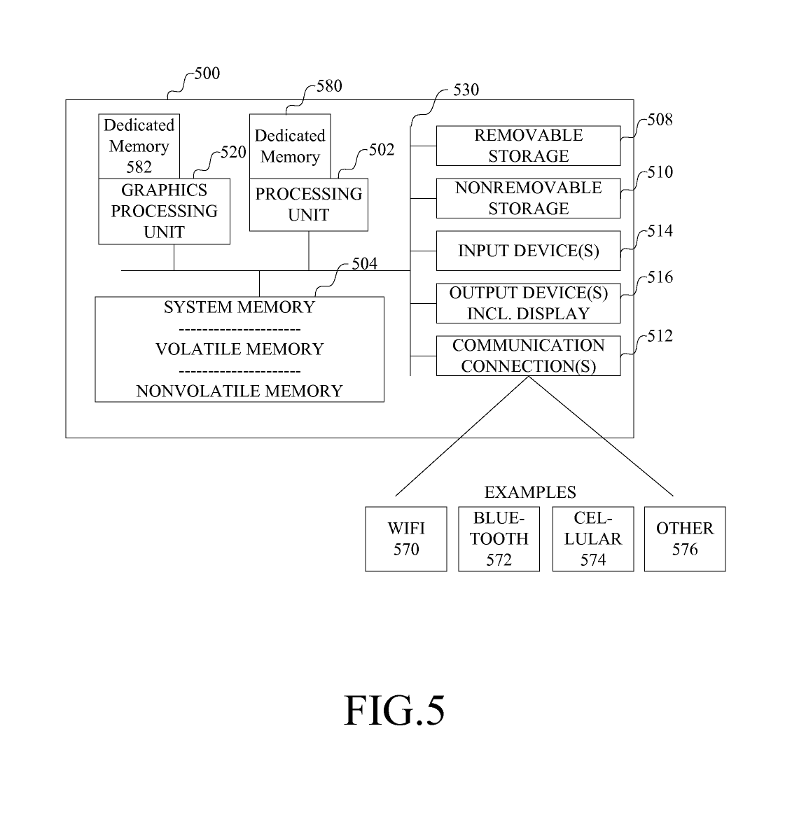

In FIG. 1, an end user computer 100 is a computer through which a developer primarily interacts with the computer system. This end user computer provides a user interface through which the developer provides instructions to the computer to create, edit, modify and delete data files, such as computer program files and related data files, and to provide instructions to the computer to compile computer programs, among other activities. Such an end user computer is implemented using a general purpose computer such as in FIG. 5.

Generally speaking, using one or more end user computers 100, one or more developers can create computer programs, also called “applications”, that use a dedicated memory of a computer, herein called a “target platform”, when the compiled computer program is executed on that computer. Such computer programs can be arbitrarily complex, and include such things as video games, computer animations and other types of computer programs with significant image processing. Such computer programs are designed to be executed on one or more target platforms. The end user computer 100 typically includes one or more compilers to generate executable computer programs for one or more target platforms, and can be implemented using a general purpose computer such as describe in connection with FIG. 5 below.

In the example computer system shown in FIG. 1, the end user computer is connected over a computer network 104 to one or more of such target platforms 102. A target platform is a computer, such as described in FIG. 5 below, which at least can run compiled computer programs. In some implementations, the target platforms 102 can be configured to compile the computer programs as well. Example target platforms include but are not limited to a game console, desktop computer, tablet computer or mobile phone.

As noted below, the target platform includes one or more processors that have a dedicated memory, such as an embedded static random access memory (ESRAM) or other dedicated, high-bandwidth memory. Such a memory generally provides fast processing with low latency, compared to other memory, but is limited in size. For example, a graphics processing unit (GPU) can have a fixed amount of dedicated memory with high bandwidth access for the GPU. Such a dedicated memory is specially designed to handle certain kinds of operations efficiently, particularly for use as a render target during image processing.

The computer system also includes storage 106 for storing computer programs 108 (including source code and compiled code for both applications and shaders) and snapshot data 110, described in more detail below. In one deployment, the end user computer 100, storage 106 and target platform 102 can be the same computer. In other deployments, a larger number of target platforms is provided, enabling compilation and/or performance testing of computer programs to be performed in parallel on multiple computers. The target platforms 102 can access compiled programs 108 and snapshot data 110 over the computer network 104 from the storage 106. Alternatively, the end user computer 100 can transmit such information from storage 106 to the target platforms 102. A variety of other arrangements can be used to control access to, compilation of and execution of computer programs by the target platforms 102.

Computer programs running on such computer systems can be written to take advantage of the graphics processing unit by specifying operations to be performed by the graphics processing unit and the resources, such as image data, textures and other data structures or data, to be used in those operations. These operations are typically implemented as computer programs called “shaders”.

The snapshot data 110 includes one or more snapshots, where each snapshot includes data and commands passed between a central processing unit and a graphics processing unit to generate a single frame of graphics data. One or more target platforms 102 can be configured to allow such snapshots to be taken during execution of an application, such as during playback of computer animation or during game play of a video game. Such snapshots are in themselves executable computer programs that can be executed on a target platform. As described in more detail below, such snapshot data is used by the computer system to improve the utilization of dedicated memory by the application. In particular, the process can improve utilization of a dedicated memory, such as an ESRAM, in a graphics processing unit, by any shaders executed on the GPU for the application.

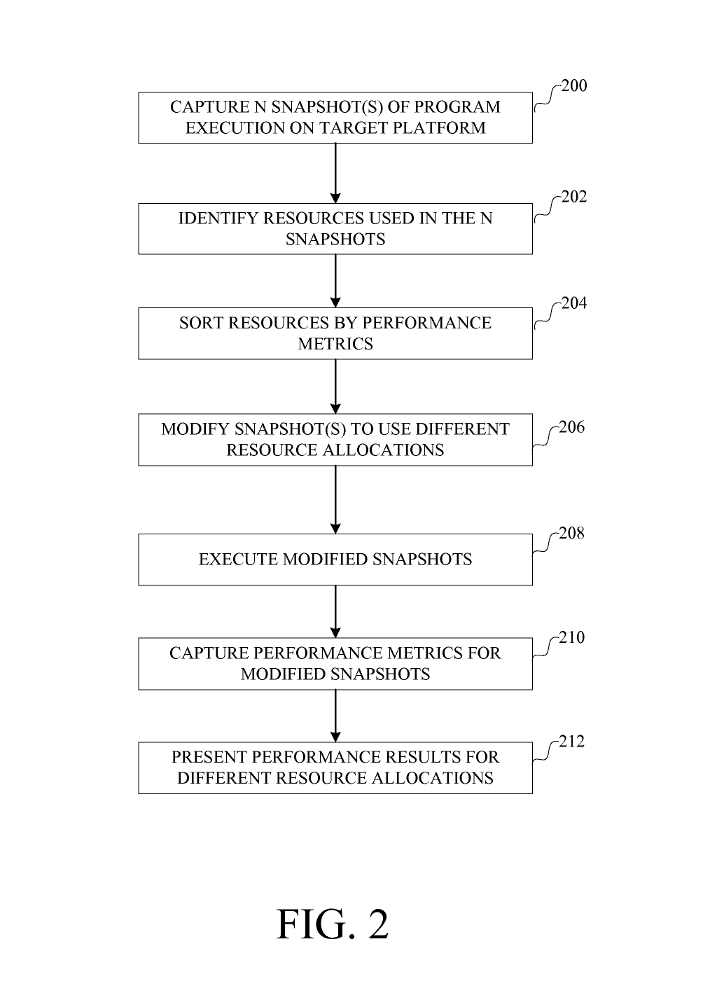

Referring now to FIG. 2, a flowchart, describing overall system operation in one implementation of the computer system, will now be described.

The process uses a plurality of snapshots taken (200) during execution of the application program. A snapshot is a data log, typically stored as a log file, that captures information about the operation of the target platform while the target platform is executed an application. In particular, a snapshot includes an indication of all data and commands passed between the central processing unit and the graphics processing unit of the target platform to generate a single frame of graphics data. The snapshots can identify, among other things, resources used in the generation of the single frame of graphics data and various performance data from which performance statistics can be derived.

Example performance statistics, include, but are not limited to, total memory bandwidth consumed for a resource, an measured amount of performance impact of that resource, or size of the resource, or other performance statistics such as time to compute the frame or time to execute a draw call using the resource. Additional performance statistics include, but are not limited to, size of the resource, bandwidth consumed by a render target, bit depth of a surface, and texture sampler settings (because, for example, anisotropic filtering benefits from faster memory).

Most development environments for computers including a GPU have the capability to capture such snapshot data, whether programmatically, under instruction of a computer program, or manually, under operation of an individual who indicates when snapshots are to be taken. By taking multiple snapshots, the computer system captures multiple execution or runtime contexts. Any positive integer number N of snapshots can be taken. Snapshots can be taken at any time during execution of the computer program.

Given N snapshots, the computer system processes the snapshots to identify (202) resources used in the snapshots. The resources are data for which memory is allocated. The resources are sorted (204) according to performance statistics for those resources which are derived from the snapshot data. Any variety of performance statistics or combination of performance statistics can be used for such sorting. For example, sorting can be based on size alone. Sorting also, or alternatively, can be based on, for example, bit depth of a surface, texture sampler settings, bandwidth consumed and the like.

The N snapshots are then modified (206) to generate a set of additional snapshots in which in the resource allocations are changed.

The additional snapshots are then re-executed 208 on the target platform. While executing these snapshots, performance statistics are again captured 210, thus providing performance statistics for the different resource allocations.

Given the results of executing the multiple snapshots, the computer system can provide various options to a developer.

As one example, the results can be presented (212) in a graphical user interface. In one implementation, results for the original snapshot can be displayed in comparison to one or more results from the additional modified snapshots, such as the results for the resource allocation determined to be best. In another implementation, the graphical user interface can allow a resource placement in a snapshot to be changed, and then re-executed.

In one implementation, the results of a resource allocation selected based on its performance can be output to a data file, such as a source code file to be used when the application program is compiled, to specify the resource allocation.

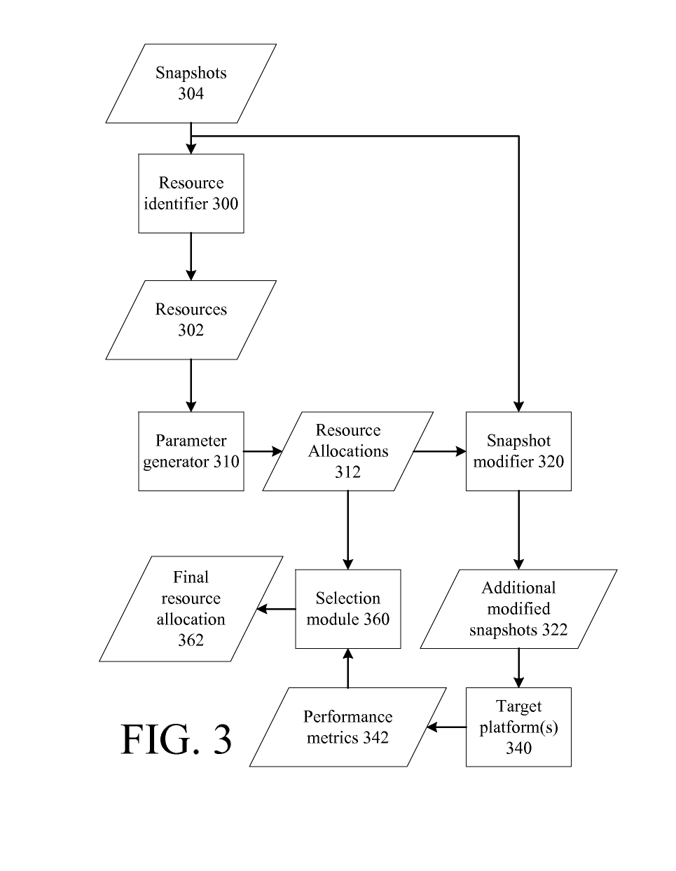

Turning now to FIG. 3, a dataflow diagram illustrates, in an example implementation, interaction of computer system components in one example implementation.

A resource identifier 300 has an input that receives a set of snapshots 304. The resource identifier processes the snapshots to identify the resources 302 for which memory is allocated for the snapshots. The resources can be those allocated in dedicated memory or in other memory. The resource identifier 300 can access and/or derive performance statistics from data in the snapshot so as to provide a sorted list of the resources 302.

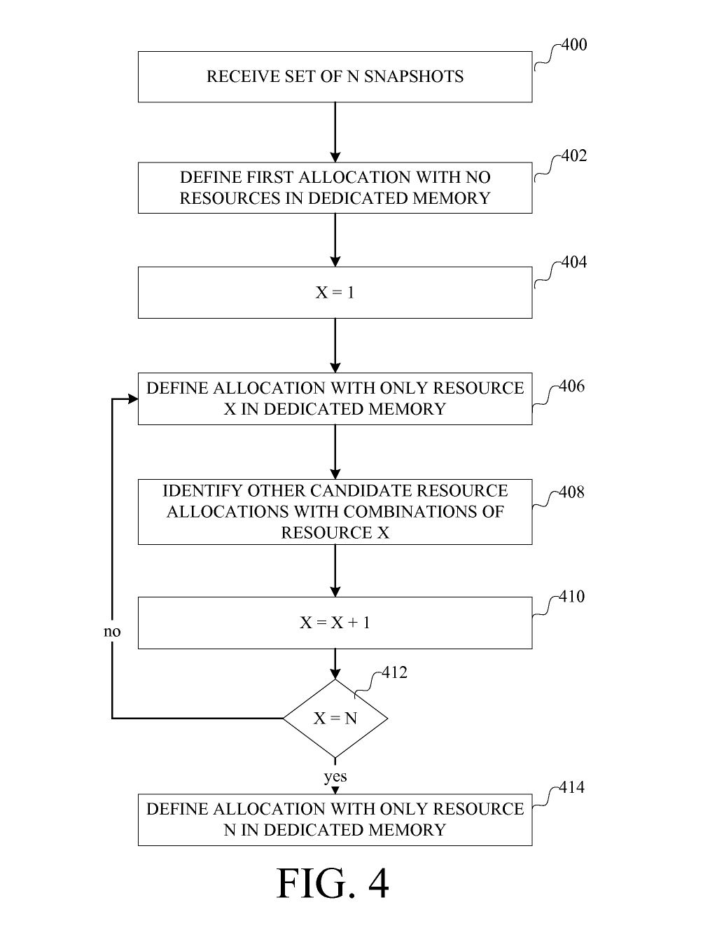

Given the sorted list of resources, a parameter generator 310 generates different permutations of allocations 312 of these resources using, in part, the dedicated memory. In one example implementation, described in more detail below in connection with FIG. 4, such permutations include assigning different combinations of zero or more resources to the dedicated memory.

The snapshot modifier 320 generates modified snapshots 322 using the different resource allocations 312. The modified snapshots 322 are applied to the target platforms 340, and performance statistics 342 are obtained.

A selection module 360 receives the performance statistics 342 that are associated with different resource allocations 312, and provide one or more final resource allocations 362 based on the measured performance. The final resource allocation 362 can be in the form of a text file, computer program code or other data indicative of a resource allocation. The selection module 360 can also provide a graphical user interface through which a developer can view information about the resource allocations and performance statistics, as described above.

Turning now to FIG. 4, an example implementation of determining different resource allocations will now be described. This process can be performed, for example, by a computer, configured by a computer program, which implements the parameter generator 310 of FIG. 3. The process begins with receiving (400) a set of N (N is a positive integer) sorted resources for which various allocations will be attempted. A first allocation is specified (402) in which none of the resources are placed in the dedicated memory. In other words, the first allocation specifies that all of the resources are placed in other memory, such as the main memory of the computer. A variable (x) is initialized (404) to 1. An allocation is then defined (406), in which resource x is placed in the dedicated memory. Each of the various possible combinations of one or more of the remaining resources (x+1 through N) are then identified (408) as candidate resource allocations, so long as all of the resources in that combination can fit within the dedicated memory. The variable x is then incremented (410). If the variable x is equal to the number of resources N, as determined at 412, then the process is completed by adding (414) a final candidate resource allocation of solely the resource N being placed in the dedicated memory. Otherwise, the process continues with determining resource allocations based on the next resource x, as indicated at 406.

In the example implementation shown in FIG. 4, all of the different permutations of combinations of resources are tried, providing an exhaustive search. In other implementations, a less exhaustive search can be performed by limiting the potential combinations based on the performance statistics related to the different resources. For example, the search can be limited by using only the largest resources first, or the most bandwidth consuming resource.

The search can be limited also by eliminating certain resources entirely from the analysis. In one particular example, in rendering three-dimensionally defined images, the computer system can be configured to identify areas which can be more easily rendered, such as backgrounds. For example, in a racing game, sky is usually at the top of an image. Because sky images are not difficult for the computer to render, such resources can be moved to main memory, and not use dedicated memory, without sacrificing too much performance. To identify such areas of an image, each portion of memory, e.g., a page, which stores the image, is known to correspond to an area of the final image. By trying different permutations of having the portions of image in and out of the dedicated memory at a time, the amount of scaling the scene receives can be determined. The different portions can be sorted in the order of performance impact to create a priority queue of the different portions of the image. Using the amount of dedicated memory allocated to this particular resource, e.g., the different portions of the image, this priority queue can be used to assign, to the dedicated memory, the most important pages first, and leave other pages in system memory.

With such a computer system, the selection of a resource allocation by an application using dedicated memory, such as for a graphics processing unit, can be optimized based on actual runtime performance statistics. The computer system also simplifies the development process and improves developer productivity.

Referring to FIG. 5, an example implementation of a general purpose computer will now be described. A general purpose computer is computer hardware that defines a processing system which is configured by computer programs which provide instructions to be executed by the processing system. Computer programs on a general purpose computer generally include an operating system and applications. The operating system is a computer program running on the computer that manages access to various resources of the computer by the applications and the operating system. The various resources generally include storage, including memory and one or more storage devices, communication interfaces, input devices and output devices.

Examples of general purpose computers include, but are not limited to, personal computers, game consoles, set top boxes, hand-held or laptop devices (for example, media players, notebook computers, tablet computers, cellular phones, personal data assistants, voice recorders), server computers, multiprocessor systems, microprocessor-based systems, programmable consumer electronics, networked personal computers, minicomputers, mainframe computers, and distributed computing environments that include any of the above types of computers or devices, and the like.

FIG. 5 illustrates an example of a processing system of a computer. An example computer 500 includes at least one processing unit 502 and storage, such as memory 504. The computer can have multiple processing units 502 and multiple devices implementing the memory 504. A processing unit 502 can include one or more processing cores (not shown) that operate independently of each other. Additional co-processing units, such as graphics processing unit 520, also can be present in the computer.

The memory 504, also called system memory, can include volatile devices (such as dynamic random access memory (DRAM) or other random access memory device), and nonvolatile devices (such as a read-only memory, flash memory, and the like) or some combination of the two. In some computer systems, a processor can have a dedicated memory, such as an embedded static random access memory (ESRAM) or other dedicated, high-bandwidth memory. Such a memory generally provides fast processing with low latency, compared to other memory, but is limited in size. For example, the central processing unit can have a dedicated memory 580. As another example, a computer system with a graphics processing unit (GPU) as a coprocessor can have a fixed amount of dedicated memory 582, such as an ESRAM, with high bandwidth access for the GPU. Such a dedicated memory is specially designed to handle certain kinds of operations efficiently, particularly for use as a render target during image processing.

The computer 500 can include additional storage, such a storage devices (whether removable or non-removable or some combination of the two) including, but not limited to, magnetically-recorded or optically-recorded disks or tape. Such additional storage is illustrated in FIG. 5 by removable storage device 508 and non-removable storage device 510. The various components in FIG. 5 are generally interconnected by an interconnection mechanism, such as one or more buses 530.

A computer storage medium is any medium in which data can be stored in and retrieved from addressable physical storage locations by the computer. Computer storage media includes volatile and nonvolatile memory devices, and removable and non-removable storage media. Memory 504, removable storage 508 and non-removable storage 510 are all examples of computer storage media. Some examples of computer storage media are RAM, ROM, EEPROM, flash memory, processor registers, or other memory technology, CD-ROM, digital versatile disks (DVD) or other optically or magneto-optically recorded storage device, magnetic cassettes, magnetic tape, magnetic disk storage or other magnetic storage devices. Computer storage media and communication media are mutually exclusive categories of media.

The computer 500 may also include communications connection(s) 512 that allow the computer to communicate with other devices over a communication medium. Communication media typically transmit computer program instructions, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal, thereby changing the configuration or state of the receiving device of the signal. By way of example, and not limitation, communication media includes wired media, including media that propagate optical and electrical signals, and wireless media include any non-wired communication media that allows propagation of signals, such as acoustic, electromagnetic, optical, infrared, radio frequency and other signals. Communications connections 512 are devices, such as a wired network interface, wireless network interface, radio frequency transceiver, e.g., Wi-Fi, cellular, long term evolution (LTE) or Bluetooth, etc., transceivers, navigation transceivers, e.g., global positioning system (GPS) or Global Navigation Satellite System (GLONASS), etc., transceivers, that interface with the communication media to transmit data over and receive data from communication media.

In a computer, example communications connections include, but are not limited to, a wireless communication interface for wireless connection to a computer network, and one or more radio transmitters for telephonic communications over cellular telephone networks, and/or. For example, a WiFi connection 572, a Bluetooth connection 574, a cellular connection 570, and other connections 576 may be present in the computer. Such connections support communication with other devices. One or more processes may be running on the processing system and managed by the operating system to enable voice or data communications over such connections.

The computer 500 may have various input device(s) 514 such as a mouse, keyboard, touch-based input devices, pen, camera, microphone, sensors, such as accelerometers, gyroscopes, thermometers, light sensors, and the like, and so on. Output device(s) 516 such as a display, speakers, and so on may also be included. All of these devices are well known in the art and need not be discussed at length here. Various input and output devices can implement a natural user interface (NUI), which is any interface technology that enables a user to interact with a device in a “natural” manner, free from artificial constraints imposed by input devices such as mice, keyboards, remote controls, and the like.

Examples of NUI methods include those relying on speech recognition, touch and stylus recognition, gesture recognition both on screen and adjacent to the screen, air gestures, head and eye tracking, voice and speech, vision, touch, gestures, and machine intelligence, and may include the use of touch sensitive displays, voice and speech recognition, intention and goal understanding, motion gesture detection using depth cameras (such as stereoscopic camera systems, infrared camera systems, and other camera systems and combinations of these), motion gesture detection using accelerometers or gyroscopes, facial recognition, three dimensional displays, head, eye, and gaze tracking, immersive augmented reality and virtual reality systems, all of which provide a more natural interface, as well as technologies for sensing brain activity using electric field sensing electrodes (EEG and related methods).

The various storage 508, 510, communication connections 512, output devices 516 and input devices 514 can be integrated within a housing with the rest of the computer hardware, or can be connected through various input/output interface devices on the computer, in which case the reference numbers 508, 510, 512, 514 and 516 can indicate either the interface for connection to a device or the device itself as the case may be.

Accordingly, in one aspect, a snapshot of execution of an application program is received. The snapshot includes data stored in storage that indicates, for a frame of graphics data generated using a graphics processing unit of the target platform, data and commands passed between a central processing unit and the graphics processing unit to generate a frame. Resources referenced in the snapshot and allocated in memory are identified. A plurality of different allocations of the identified resources in the main memory and the dedicated memory are determined. The snapshots are modified to use the generated plurality of different allocations of the identified resources. The modified snapshots are executed on the target platform, while capturing performance statistics. One or more allocations of resources are identified from among the plurality of different allocations according to the performance statistics.

In one aspect, a computer system includes a means for identifying resources referenced in a snapshot of execution of an application, means for generating permutations of resource allocations for the resources in dedicated memory, and means for measuring performance of the application with different resource allocations for the application.

Another aspect is an executable application program which includes allocations of a dedicated memory, wherein the allocation is generated using a process performed by a computer system as described in any of the foregoing aspects.

In any of the foregoing aspects, a processing system is further configured to compile the application program with the identified allocation of resources.

In any of the foregoing aspects, to generate the plurality of different allocations, a processing system is further configured to perform a search of possible combinations of the resources to be allocated in the dedicated memory.

In any of the foregoing aspects, the performance statistics can include time of execution to generate the frame. Alternatively, the performance statistics can include time of execution of one or more draw calls. Alternatively, the performance statistics can include any one of time of execution to generate the frame or time of execution of one or more draw calls. Alternatively, the performance statistics can include time of execution to generate the frame and time of execution of one or more draw calls.

In any of the foregoing aspects, the snapshot includes graphics events referencing resources used by the graphics processing unit to generate the frame. The resources can be in an embedded static random access memory (ESRAM) of the graphics processing unit.

In any of the foregoing aspects, the identified allocation of resources is output to a computer program file that configures a compiler to compile the application program with the identified allocation of resources.

Any of the foregoing aspects may be embodied as a computer system, as any individual component of such a computer system, as a process performed by such a computer system or any individual component of such a computer system, or as an article of manufacture including computer storage in which computer program instructions are stored and which, when processed by one or more computers, configure the one or more computers to provide such a computer system or any individual component of such a computer system.

Each component (which also may be called a “module” or “engine” or the like), of a computer system such as described herein, and which operates on the computer, can be implemented using the one or more processing units of the computer and one or more computer programs processed by the one or more processing units. Generally speaking, such modules have inputs and outputs through locations in memory or processor registers from which data can be read and to which data can be written when the module is executed by the processor. A computer program includes computer-executable instructions and/or computer-interpreted instructions, such as program modules, which instructions are processed by one or more processing units in the computer. Generally, such instructions define routines, programs, objects, components, data structures, and so on, that, when processed by a processing unit, instruct the processing unit to perform operations on data or configure the processor or computer to implement various components or data structures.

Alternatively, or in addition, the functionality of one or more of the various components described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

It should be understood that the subject matter defined in the appended claims is not necessarily limited to the specific implementations described above. The specific implementations described above are disclosed as examples only.

What is claimed is:

1. A computer system, comprising:
a target platform comprising a computer having a central processing unit, a graphics processing unit and memory, the memory including main memory and dedicated memory, wherein the target platform is configured by an application program that configures the graphics processing unit to generate frames of graphics data using resources allocated in the memory;
the target platform further being configured to capture a snapshot of execution of the application program, the snapshot including data stored in storage that indicates, for a frame of graphics data generated using the graphics processing unit, data and commands passed between the central processing unit and the graphics processing unit to generate the frame;
a computer having a processing system configured to:
receive a plurality of snapshots of execution of the application on the target platform;
identify resources referenced in the snapshot and allocated in the memory;
generate a plurality of different allocations of the identified resources in the main memory and the dedicated memory;
modify the snapshots to use the generated plurality of different allocations of the identified resources;
execute the modified snapshots on the target platform while capturing performance statistics; and
identify one or more allocations of resources from among the plurality of different allocations according to the performance statistics.

2. The computer system of claim 1, wherein the processing system is further configured to compile the application program with the identified allocation of resources.

3. The computer system of claim 1, wherein to generate the plurality of different allocations, the processing system is further configured to perform a search of possible combinations of the resources to be allocated in the dedicated memory.

4. The computer system of claim 1, wherein the performance statistics include time of execution to generate the frame.

5. The computer system of claim 1, wherein the performance statistics include time of execution of one or more draw calls.

6. The computer system of claim 1, wherein the snapshot includes graphics events referencing resources used by the graphics processing unit to generate the frame.

7. The computer system of claim 1, wherein the identified allocation of resources is output to a computer program file that configures a compiler to compile the application program with the identified allocation of resources.

8. An article of manufacture comprising:
storage comprising at least one of a memory device and a storage device; and
computer program instructions stored on the storage which, when processed by a processing system of a computer, configures the processing system to:
receive a plurality of snapshots of execution of an application on a target platform, wherein the target platform comprises a computer having a central processing unit, a graphics processing unit and memory, the memory including main memory and dedicated memory, wherein the target platform is configured by the application which configures the graphics processing unit to generate frames of graphics data using resources allocated in the memory, wherein a snapshot includes data stored in storage that indicates, for a frame of graphics data generated using the graphics processing unit, data and commands passed between the central processing unit and the graphics processing unit to generate the frame;
identify resources referenced in the snapshot and allocated in the memory;
generate a plurality of different allocations of the identified resources in the main memory and the dedicated memory;
modify the snapshots to use the generated plurality of different allocations of the identified resources;
execute the modified snapshots on the target platform while capturing performance statistics; and
identify one or more allocations of resources from among the plurality of different allocations according to the performance statistics.

9. The article of manufacture of claim 8, wherein the processing system is further configured to compile the application program with the identified allocation of resources.

10. The article of manufacture of claim 8, wherein to generate the plurality of different allocations, the processing system is further configured to perform a search of possible combinations of the resources to be allocated in the dedicated memory.

11. The article of manufacture of claim 8, wherein the performance statistics include time of execution to generate the frame.

12. The article of manufacture of claim 8, wherein the performance statistics include time of execution of one or more draw calls.

13. The article of manufacture of claim 8, wherein the snapshot includes graphics events referencing resources used by the graphics processing unit to generate the frame.

14. The article of manufacture of claim 8, wherein the identified allocation of resources is output to a computer program file that configures a compiler to compile the application program with the identified allocation of resources.

15. A process performed by computer system including a processing system, the process comprising:
receiving a snapshot from a target platform, wherein the target platform comprises a computer having a central processing unit, a graphics processing unit and memory, the memory including main memory and dedicated memory, wherein the target platform is configured by the application which configures the graphics processing unit to generate frames of graphics data using resources allocated in the memory, wherein a snapshot includes data stored in storage that indicates, for a frame of graphics data generated using the graphics processing unit, data and commands passed between the central processing unit and the graphics processing unit to generate the frame;
identifying resources referenced in the snapshot and allocated in the memory;
generating a plurality of different allocations of the identified resources in the main memory and the dedicated memory;
modifying the snapshots to use the generated plurality of different allocations of the identified resources;
executing the modified snapshots on the target platform while capturing performance statistics; and
identifying one or more allocations of resources from among the plurality of different allocations according to the performance statistics.

16. The process of claim 15, further comprising compiling the application program with the identified allocation of resources.

17. The process of claim 15, wherein generating the plurality of different allocations comprises performing a search of possible combinations of the resources to be allocated in the dedicated memory.

18. The process of claim 15, wherein the performance statistics include time of execution to generate the frame.

19. The process of claim 15, wherein the performance statistics include time of execution of one or more draw calls.

20. The process of claim 15, wherein the snapshot includes graphics events referencing resources used by the graphics processing unit to generate the frame.
